(19) United States
(12) Patent Application Publication
(10) Pub. No.: US 2026/0106701 A1
(43) Pub. Date: Apr. 16, 2026

(54) ULTRA-WIDEBAND CARRIER AGGREGATION TRANSMISSION METHOD AND DEVICE

(71) Applicant: INDUSTRY-ACADEMIC COOPERATION FOUNDATION, DANKOOK UNIVERSITY, Yongin-si, Gyeonggi-do (KR)

(72) Inventor: Suhan Choi, Gwacheon-si, Gyeonggi-do (KR)

(73) Assignee: INDUSTRY-ACADEMIC COOPERATION FOUNDATION, DANKOOK UNIVERSITY, Yongin-si, Gyeonggi-do (KR)

(21) Appl. No.: 19/112,247

(22) PCT Filed: Sep. 25, 2023
(86) PCT No.: PCT/KR2023/014672

§ 371 Date: Dec. 30, 2025

(30) Foreign Application Priority Data
Sep. 30, 2022 (KR) 10-2022-0125079
Sep. 13, 2023 (KR) 10-2023-0121905

(51) Int. Cl. H04L 5/00; H04W 24/02; H04W 76/27

(52) U.S. Cl. CPC H04L 5/001; H04W 24/02; H04W 76/27

(57) ABSTRACT

Next-generation wireless communication systems may use ultra-wideband such as mmWave or sub-THz bands to increase communication efficiency. The present disclosure proposes an ultra-wideband frequency aggregation transmission method and a device using the method. According to one embodiment of the present disclosure, throughput and energy efficiency of a terminal and a system can be improved by continuously updating an optimal component carrier combination for a terminal.

### TECHNICAL FIELD

The present disclosure relates to wireless communication, and more particularly, to a method and apparatus for ultra-wideband carrier aggregation transmission.

### BACKGROUND ART

The 6G (sixth generation) wireless communication system aims at (i) very high data rates per device, (ii) a very large number of connected devices, (iii) global connectivity, (iv) very low latency, (v) reduced energy consumption of battery-free Internet-of-Things (IoT) devices, (vi) ultra-reliable connectivity, and (vii) connected intelligence with machine learning capabilities. Usage scenarios of the 6G system may include six aspects: Immersive Communication, Hyper Reliable & Low-Latency Communication, Massive Communication, Ubiquitous Connectivity, Integrated AI and Communication, Integrated Sensing and Communication.

6G mobile communications may use ultra-widebands such as Sub-THz (terahertz) and THz bands in addition to the existing mmWave (millimeter wave) band. Adding the Sub-THz band to the mm Wave band makes it easier to increase the channel bandwidth because more frequency resources can be used, which in turn increases the data transmission rate and cell throughput. Among the defined THz bands, 300 GHz-3 THz is in the infrared (IR) frequency band. The 300 GHz-3 THz band is part of the optical band, but it is at the boundary of the optical band and is just behind the radio frequency (RF) band. Therefore, this 300 GHz-3 THz band shows similarities with RF.

Carrier Aggregation (CA) system means aggregating multiple component carriers (CCs). Due to this carrier aggregation, the meaning of the existing cell has changed. According to carrier aggregation, a cell may mean a combination of a downlink component carrier and an uplink component carrier, or a single downlink component carrier.

Carrier aggregation may also be used in 6G mobile communications. For example, in 6G mobile communications, an ultra-wideband channel bandwidth may be used as the frequency band increases. Here, in a 6G mobile communications environment where various terminals such as legacy terminals and the latest terminals coexist, the ultra-wideband channel bandwidth may be divided into multiple CCs having relatively small units in consideration of the capability and backward capability of the terminals, and the CCs may be used for carrier aggregation. In addition, when it is difficult for one terminal to use the entire wideband and only some of the frequency resources are used, carrier aggregation may be used.

### DETAILED DESCRIPTION OF INVENTION

### Technical Solution

The present disclosure proposes a method and apparatus for ultra-wideband carrier aggregation transmission.

### Effect of Invention

According to the present specification, when using multiple frequency bands such as mmWave, Sub-THz, and ultra-wideband frequency resources and multiple Transmission and Reception Points (TRPs) in a single cell, the optimal CC combination can be continuously updated and applied by reflecting the situation in which the channel status continuously changes in time and space within a single cell for each terminal according to the current channel status and serving TRP of the terminal, and therefore, the throughput and energy efficiency of each terminal and the system can be increased. In addition, when the system applies CA to the corresponding terminal, the system reflects the channel information received from the terminal and the information for setting the optimal CC set, and allocates the optimal CC set and the corresponding frequency resources, thereby providing the optimal link to each terminal and significantly reducing interference signals within the cell, thereby improving system performance. In addition, when applying CA with ultra-wideband to the system, since there are terminals with various capabilities in the cell, the method of updating the optimal CC set as described in the present specification according to the capability of the terminal and communicating can be quite effective. In addition, by analyzing information about the optimal CC set at one location within a cell with an AI system and pre-setting the optimal CC set in the system according to the capability and location of the terminal and utilizing this, cell throughput and energy efficiency of the terminal can be significantly improved.

The effects that can be obtained through specific examples of this specification are not limited to the effects listed above. For example, there may be various technical effects that a person having ordinary skill in the related art can understand or derive from this specification. Accordingly, the specific effects of this specification are not limited to those explicitly described in this specification, and may include various effects that can be understood or derived from the technical features of this specification.

### BRIEF DESCRIPTION OF THE DRAWING

The drawings or figures (FIGs) below are created to illustrate specific examples of the present specification. The names of specific devices or names of specific signals/messages/fields depicted in the drawings are presented as examples, and therefore the technical features of the present specification are not limited to the specific names used in the drawings below.

FIG. 1 is a conceptual diagram illustrating a wireless communication system according to one embodiment of the present invention.

FIG. 2 is a block diagram showing a radio protocol architecture for a user plane.

FIG. 3 is a block diagram showing a radio protocol architecture for a control plane.

FIG. 4 shows another example of a wireless communication system to which the technical features of the present disclosure can be applied.

FIG. 5 illustrates the functional partition between NG-RAN and 5GC.

FIG. 6 illustrates a frame structure that can be applied in 5G NR.

FIG. 7 shows the resource structure of the frequency and time domains of 5G NR.

FIG. 8 illustrates an example in which carriers in the below-6 GHz band, mm Wave band, and sub-THz band are aggregated.

FIG. 9 is a flowchart of an example of an optimal CC set setting method for ultra-wideband CA according to some implementations of the present specification.

FIG. 10 is a flowchart of an example of a method for performing a CA-based operation reflecting an optimal CC set by a terminal in an ACTIVE state according to some implementations of the present specification.

FIG. 11 illustrates an example of a communication system (1) applied to the present invention.

FIG. 12 illustrates an example of a wireless device applicable to the present invention.

FIG. 13 illustrates an example of a process for generating a transmission signal from a transmitter.

FIG. 14 shows another example of a wireless device applied to the present invention.

### BEST MODE FOR CARRYING OUT THE INVENTION

In the present specification, “A or B” may mean “only A,” “only B,” or “both A and B.” In other words, “A or B” in the present specification may be interpreted as “A and/or B.” For example, “A, B or C” in the present specification may mean “only A,” “only B,” “only C,” or “any combination of A, B and C.”

A slash (/) or a comma used in the present specification may mean “and/or.” For example, “A/B” may mean “A and/or B.” Accordingly, “A/B” may mean “only A,” “only B,” or “both A and B.” For example, “A, B, C” may mean “A, B, or C.”

As used herein, “at least one of A and B” may mean “only A”, “only B” or “both A and B”. Additionally, as used herein, the expressions “at least one of A or B” or “at least one of A and/or B” may be interpreted identically to “at least one of A and B”.

Additionally, in the present specification, “at least one of A, B and C” may mean “only A,” “only B,” “only C,” or “any combination of A, B and C.” Additionally, “at least one of A, B or C” or “at least one of A, B and/or C” may mean “at least one of A, B and C.”

In addition, the parentheses used in the present specification may mean “for example.” Specifically, when indicated as “control information (PDCCH),” “PDCCH” may be proposed as an example of “control information.” In other words, “control information” in the present specification is not limited to “PDCCH,” and “PDCCH” may be proposed as an example of “control information.” In addition, even when indicated as “control information (i.e., PDCCH),” “PDCCH” may be proposed as an example of “control information.”

Technical features individually described in one drawing or figure in the present specification may be implemented individually or simultaneously.

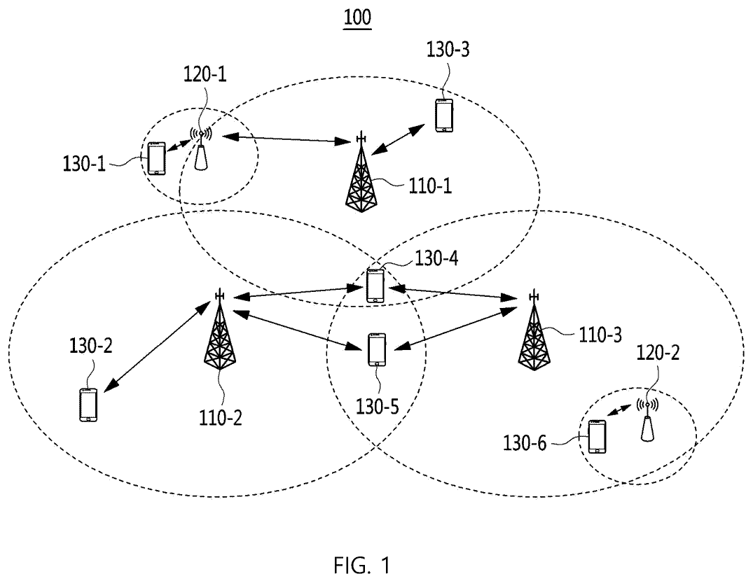

FIG. 1 is a conceptual diagram illustrating a wireless communication system according to one embodiment of the present invention.

Referring to FIG. 1, the wireless communication system (100) may be composed of a plurality of communication nodes (110-1, 110-2, 110-3, 120-1, 120-2, 130-1, 130-2, 130-3, 130-4, 130-5, 130-6).

Each of the plurality of communication nodes may support at least one communication protocol. For example, each of the plurality of communication nodes may support a communication protocol based on CDMA (Code Division Multiple Access), a communication protocol based on WCDMA (Wideband CDMA), a communication protocol based on TDMA (Time Division Multiple Access), a communication protocol based on FDMA (Frequency Division Multiple Access), a communication protocol based on OFDM (Orthogonal Frequency Division Multiplexing), a communication protocol based on OFDMA (Orthogonal Frequency Division Multiple Access), a communication protocol based on SC (Single Carrier)-FDMA, a communication protocol based on NOMA (Non-Orthogonal Multiple Access), a communication protocol based on SDMA (space division multiple access), etc.

A wireless communication system (100) may include a plurality of base stations (110-1, 110-2, 110-3, 120-1, 120-2) and a plurality of user equipments (130-1, 130-2, 130-3, 130-4, 130-5, 130-6).

Each of the first base station (110-1), the second base station (110-2), and the third base station (110-3) can form a macro cell. Each of the fourth base station (120-1) and the fifth base station (120-2) can form a small cell. The fourth base station (120-1), the third terminal (130-3) and the fourth terminal (130-4) can be within the coverage of the first base station (110-1). The second terminal (130-2), the fourth terminal (130-4), and the fifth terminal (130-5) can be within the coverage of the second base station (110-2). The fifth base station (120-2), the fourth terminal (130-4), the fifth terminal (130-5), and the sixth terminal (130-6) may be within the coverage of the third base station (110-3). The first terminal (130-1) may be within the coverage of the fourth base station (120-1). The sixth terminal (130-6) may be within the coverage of the fifth base station (120-2).

Herein, each of the plurality of base stations (110-1, 110-2, 110-3, 120-1, 120-2) may be referred to as a NodeB, an evolved NodeB, a next generation Node B (gNB), a next generation 6G base station, a Base Transceiver Station (BTS), a radio base station, a radio transceiver, an access point, an access node, a road side unit (RSU), a Digital Unit (DU), a Cloud Digital Unit (CDU), a Radio Remote Head (RRH), a Radio Unit (RU), a Transmission Point (TP), a transmission and reception point (TRP), a relay node, etc. Each of the plurality of terminals (130-1, 130-2, 130-3, 130-4, 130-5, 130-6) may be referred to as a terminal, an access terminal, a mobile terminal, a station, a subscriber station, a mobile station, a portable subscriber station, a node, a device, etc.

Each of the plurality of communication nodes (110-1, 110-2, 110-3, 120-1, 120-2, 130-1, 130-2, 130-3, 130-4, 130-5, 130-6) can support cellular communication (e.g., long term evolution (LTE), advanced (LTE-A), new radio (NR), 6G radio access technology as specified in the 3rd generation partnership project (3GPP) standard). Each of the plurality of base stations (110-1, 110-2, 110-3, 120-1, 120-2) can operate in a different frequency band or can operate in the same frequency band. Each of the plurality of base stations (110-1, 110-2, 110-3, 120-1, 120-2) can be connected to each other via an ideal backhaul or a non-ideal backhaul, and can exchange information with each other via the ideal backhaul or the non-ideal backhaul. Each of the plurality of base stations (110-1, 110-2, 110-3, 120-1, 120-2) can be connected to a core network via an ideal backhaul or a non-ideal backhaul. Each of the plurality of base stations (110-1, 110-2, 110-3, 120-1, 120-2) can transmit a signal received from the core network to the corresponding terminal (130-1, 130-2, 130-3, 130-4, 130-5, 130-6), and can transmit a signal received from the corresponding terminal (130-1, 130-2, 130-3, 130-4, 130-5, 130-6) to the core network.

Each of the plurality of base stations (110-1, 110-2, 110-3, 120-1, 120-2) can support downlink transmission based on OFDM or another transmission method. In addition, each of the plurality of base stations (110-1, 110-2, 110-3, 120-1, 120-2) can support uplink transmission based on OFDM or DFT-Spread-OFDM or another transmission method. In addition, each of the plurality of base stations (110-1, 110-2, 110-3, 120-1, 120-2) may support MIMO (Multiple Input Multiple Output) transmission (e.g., SU (Single User)-MIMO, MU (Multi User)-MIMO, massive MIMO, LoS (Line of Sight) MIMO, etc.), CoMP (Coordinated Multipoint) transmission, carrier aggregation transmission, transmission in an unlicensed band, device to device (D2D) communication (or, ProSe (proximity services)), Sidelink, etc. Herein, each of the plurality of terminals (130-1, 130-2, 130-3, 130-4, 130-5, 130-6) can perform an operation corresponding to the base station (110-1, 110-2, 110-3, 120-1, 120-2) and/or an operation supported by the base station (110-1, 110-2, 110-3, 120-1, 120-2).

Hereinafter, even if a method (e.g., transmitting or receiving a signal) performed by a first communication node among communication nodes is described, a second communication node corresponding thereto can perform a method (e.g., receiving or transmitting a signal) corresponding to the method performed by the first communication node. That is, if an operation of a terminal is described, a corresponding base station can perform an operation corresponding to the operation of the terminal. Conversely, if an operation of a base station is described, a corresponding terminal can perform an operation corresponding to the operation of the base station.

Also, hereinafter, downlink (DL) means communication from a base station to a terminal, and uplink (UL) means communication from a terminal to a base station. In downlink, a transmitter may be part of a base station, and a receiver may be part of a terminal. In uplink, a transmitter may be part of a terminal, and a receiver may be part of a base station.

Hereinafter, in the present specification, for convenience of explanation, the next generation wireless access technology may be referred to as New RAT (Radio Access Technology) or may be referred to by other names. For example, a wireless communication system to which New RAT is applied may be referred to as an NR (New Radio) system. In this specification, frequencies, frames, subframes, resources, resource blocks, regions, bands, subbands, control channels, data channels, synchronization signals, various reference signals, various signals or various messages related to the next generation wireless access technology may be interpreted as having past or present meanings or various meanings used in the future.

As more and more communication devices require greater communication capacity, the need for improved mobile broadband communication is increasing compared to existing radio access technology (RAT). In addition, massive Machine Type Communications (MTC), which connects a large number of devices and objects to provide various services anytime and anywhere, is also one of the major issues to be considered in next-generation communication. In addition, a communication system design that considers services/terminals that are sensitive to reliability and latency is being discussed. The introduction of next-generation wireless access technologies that consider enhanced mobile broadband communication, massive MTC, URLLC (Ultra-Reliable and Low Latency Communication), etc. is being discussed, and for convenience, the technology is called 5G wireless communication or 5G mobile communication in the present disclosure.

The layers of the Radio Interface Protocol between the terminal and the network can be divided into L1 (Layer 1), L2 (Layer 2), and L3 (Layer 3) based on the three lower layers of the Open System Interconnection (OSI) standard model, which is widely known in communication systems. Among these, the Physical layer belonging to Layer 1 provides an Information Transfer Service using a physical channel, and the RRC (Radio Resource Control) layer located in Layer 3 controls radio resources between the terminal and the network. For this purpose, the RRC layer exchanges RRC messages between the terminal and the base station.

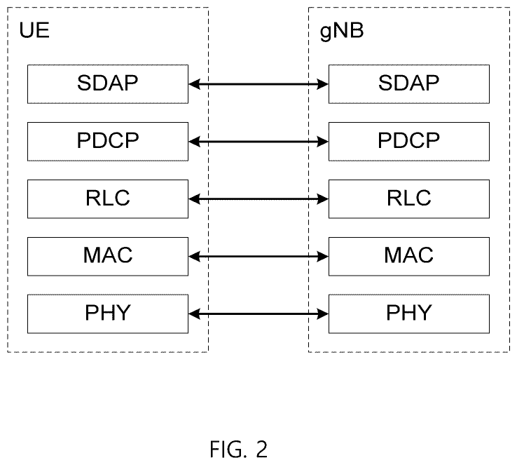

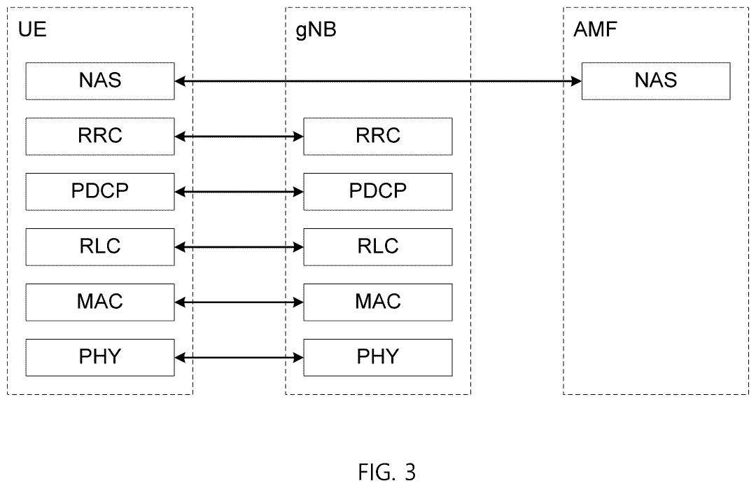

FIG. 2 is a block diagram showing a radio protocol architecture for a user plane. FIG. 3 is a block diagram showing a radio protocol architecture for a control plane. The user plane is a protocol stack for transmitting user data, and the control plane is a protocol stack for transmitting control signals.

Referring to FIGS. 2 and 3, the physical layer (PHY layer) provides information transfer service to the upper layer using a physical channel. The physical layer is connected to the upper layer, the Medium Access Control (MAC) layer, through a transport channel. Data moves between the MAC layer and the physical layer through the transport channel. The transport channel is classified according to how and with what characteristics data is transmitted through the wireless interface.

Data is transferred between different physical layers, that is, between the physical layers of the transmitter and receiver, through a physical channel. The physical channel can be modulated using the OFDM (Orthogonal Frequency Division Multiplexing) method, and uses time and frequency as radio resources.

The functions of the MAC layer include mapping between logical channels and transport channels, and multiplexing/demultiplexing of MAC SDU (service data unit) belonging to logical channels into transport blocks provided as physical channels on the transport channels. The MAC layer provides services to the RLC (Radio Link Control) layer through logical channels.

The functions of the RLC layer include concatenation, segmentation, and reassembly of RLC SDUs. In order to guarantee various Quality of Service (QoS) required by the Radio Bearer (RB), the RLC layer provides three operation modes: Transparent Mode (TM), Unacknowledged Mode (UM), and Acknowledged Mode (AM). AM RLC provides error correction through automatic repeat request (ARQ).

The RRC (Radio Resource Control) layer is defined only in the control plane. The RRC layer is responsible for controlling logical channels, transport channels, and physical channels in relation to the configuration, re-configuration, and release of radio bearers. RB refers to a logical path provided by the first layer (PHY layer) and the second layer (MAC layer, RLC layer, PDCP layer) for data transmission between the terminal and the network.

The function of the SDAP (Service Data Adaptation Protocol) layer in the user plane includes mapping the QoS flow between the core network and the terminal to the Radio Bearer (RB) in the wireless section. The function of the PDCP (Packet Data Convergence Protocol) layer includes transfer of user data, header compression, and ciphering. The function of the PDCP (Packet Data Convergence Protocol) layer in the control plane includes transfer of control plane data and ciphering/integrity protection.

Establishing a RB means the process of specifying the characteristics of the wireless protocol layer and channel to provide a specific service, and setting each specific parameter and operation method. RB can be divided into two: SRB (Signaling RB) and DRB (Data RB). SRB is used as a channel to transmit RRC messages in the control plane, and DRB is used as a channel to transmit user data in the user plane.

When a RRC connection is established between the RRC layer of the terminal and the RRC layer of the base station, the terminal is in the RRC connected state, otherwise it is in the RRC idle state.

Downlink transmission channels that transmit data from a network to a terminal include the BCH (Broadcast Channel) that transmits MIB (Master Information Block) among system information, SIBs (System Information Blocks) that are system information other than MIB, and the downlink SCH (Shared Channel) that transmits user traffic or control messages. Traffic or control messages of downlink multicast or broadcast services may be transmitted through the downlink SCH, or may be transmitted through a separate downlink MCH (Multicast Channel). Meanwhile, uplink transmission channels that transmit data from a terminal to a network include the RACH (Random Access Channel) that transmits initial control messages, and the uplink SCH (Shared Channel) that transmits user traffic or control messages.

Logical channels that are located above the transport channel and are mapped to the transport channel include BCCH (Broadcast Control Channel), PCCH (Paging Control Channel), CCCH (Common Control Channel), MCCH (Multicast Control Channel), DTCH (Dedicated Traffic Channel), and MTCH (Multicast Traffic Channel).

In the case of 5G NR, a physical channel consists of multiple OFDM symbols in the time domain and multiple subcarriers in the frequency domain. One subframe consists of multiple OFDM symbols in the time domain. A resource block (RB) is a resource allocation unit and consists of multiple subcarriers. In addition, each subframe can use specific subcarriers of specific OFDM symbols (e.g., the first OFDM symbol) of the corresponding subframe for the Physical Downlink Control Channel (PDCCH), i.e., the L1/L2 control channel. In 5G NR, a slot is used as a unit time for transmission.

For 5G NR systems, a SDAP (Service Data Adaptation Protocol) layer may exist above the PDCP layer. The SDAP layer is a layer added to the user plane in a 5G system, is included on both the UE and gNB sides, and is a layer that manages service quality and maps QoS flows to radio bearers.

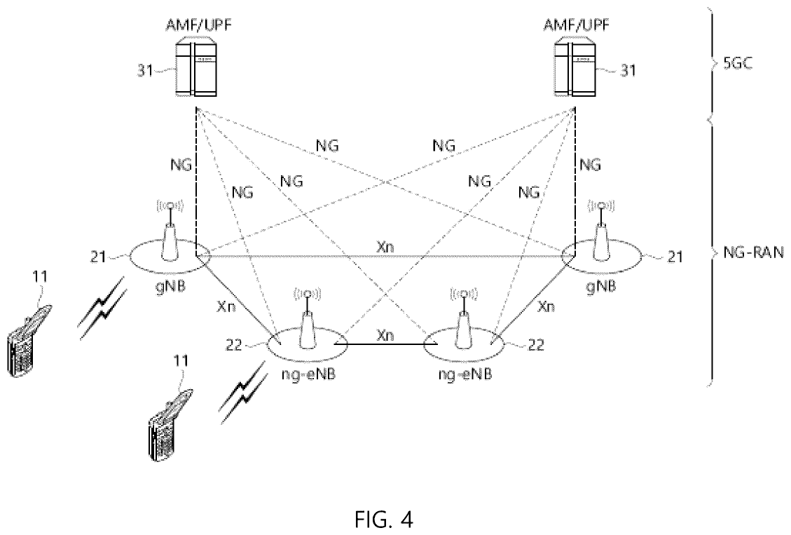

FIG. 4 shows another example of a wireless communication system to which the technical features of the present disclosure can be applied.

Specifically, FIG. 4 illustrates a system architecture based on a 5G NR (new radio) system. Entities used in a 5G NR system (hereinafter, simply referred to as “NR”) may absorb some or all of the functions of entities (e.g., eNB, MME, S-GW) in an LTE system. Entities used in an NR system may be identified by the name “NG” to distinguish them from LTE.

Referring to FIG. 4, the wireless communication system includes one or more UEs (11), a next-generation RAN (NG-RAN), and a fifth-generation core network (5GC). The NG-RAN is composed of at least one NG-RAN node. The NG-RAN node is an entity corresponding to the BS (20) illustrated in FIG. 1. The NG-RAN node is composed of at least one gNB (21) and/or at least one ng-eNB (22). The gNB (21) provides termination of NR user plane and control plane protocols toward the UE (11). The ng-eNB (22) provides termination of E-UTRA user plane and control plane protocols toward the UE (11).

5GC includes access and mobility management function (AMF), user plane function (UPF), and session management function (SMF). AMF hosts functions such as NAS security, idle state mobility handling, etc. AMF is an entity that includes functions of a conventional MME. UPF hosts functions such as mobility anchoring, protocol data unit (PDU) handling. UPF is an entity that includes functions of a conventional S-GW. SMF hosts functions such as UE IP address allocation, PDU session control.

gNB and ng-eNB are interconnected via Xn interface. gNB and ng-eNB are also connected to 5GC via NG interface. More specifically, they are connected to AMF via NG-C interface and to UPF via NG-U interface.

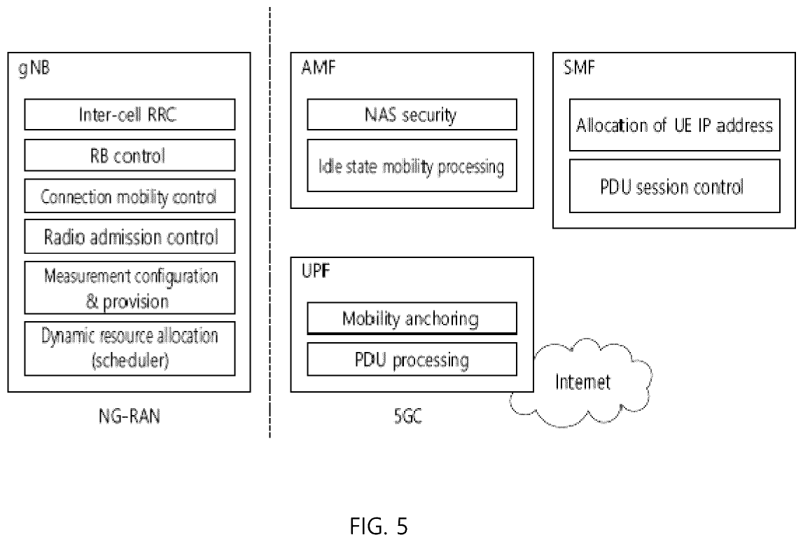

FIG. 5 illustrates the functional partition between NG-RAN and 5GC.

Referring to FIG. 5, the gNB can provide functions such as inter-cell radio resource management (RRM), RB control, Connection Mobility Control, Radio Admission Control, Measurement configuration & Provision, and dynamic resource allocation. The AMF can provide functions such as NAS security and idle state mobility processing. The UPF can provide functions such as mobility anchoring and PDU processing. The SMF (Session Management Function) can provide functions such as terminal IP address allocation and PDU session control.

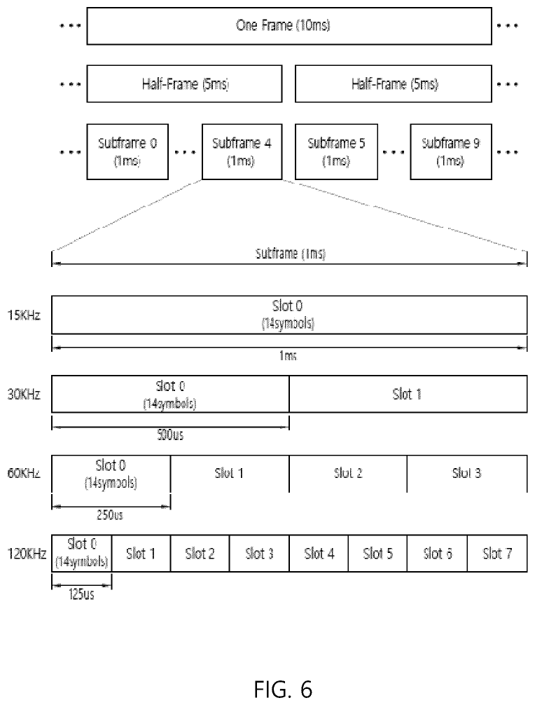

FIG. 6 illustrates a frame structure that can be applied in 5G NR.

Referring to FIG. 6, a frame can be composed of 10 ms (milliseconds) and can include 10 subframes composed of 1 ms.

In NR, uplink and downlink transmissions can be structured into frames. A radio frame has a length of 10 ms and can be defined by two 5 ms half-frames (HF). A half-frame can be defined by five 1 ms subframes (SF). A subframe is divided into one or more slots, and the number of slots in a subframe depends on Subcarrier Spacing (SCS). Each slot contains 12 or 14 OFDM (A) symbols depending on the cyclic prefix (CP). When a normal CP is used, each slot contains 14 symbols. When an extended CP is used, each slot contains 12 symbols. Here, a symbol can include an OFDM symbol (or a CP-OFDM symbol) or a DFT-s-OFDM symbol.

A subframe may contain one or more slots depending on the subcarrier spacing.

The following Table 1 illustrates the subcarrier spacing configuration μ.

TABLE 1

| μ | Δf = 2^{μ} · 15[kHz] | CP (Cyclic Prefix) |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows examples of the number of slots in a frame (N^{frame,μ}ₛₗₒₜ), the number of slots in a subframe (N^{subframe,μ}ₛₗₒₜ), and the number of symbols in a slot (N^{slot}_{symb}), depending on the subcarrier spacing configuration u.

TABLE 2

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 illustrates the number of symbols per slot, the number of slots per frame, and the number of slots per subframe (SF) according to SCS when extended CP is used.

TABLE 3

| SCS (15 · 2^{μ}) | N^{slot}_{symb} | N^{frame, μ}ₛₗₒₜ | N^{subframe, μ}ₛₗₒₜ |
|---|---|---|---|
| 60 kHz (μ = 2) | 12 | 40 | 4 |

NR supports multiple numerologies (or subcarrier spacings (SCS)) to support various 5G services. For example, when the SCS is 15 kHz, it supports wide area in traditional cellular bands, when the SCS is 30 kHz/60 kHz, it supports dense-urban, lower latency and wider carrier bandwidth, and when the SCS is 60 kHz or higher, it supports frequency bands higher than 24.25 GHz.

The NR frequency band can be defined by two types of frequency ranges (FR1, FR2). The numerical values of the frequency ranges can be changed, and for example, the two types of frequency ranges (FR1, FR2) can be as shown in Table 4 below. Table 4 corresponds to the initial specifications of 3GPP 5G NR and was later changed to Table 5. For convenience of explanation, among the frequency ranges used in the NR system, FR1 can mean “sub 6 GHz range”, and FR2 can mean “above 6 GHz range” and can be called millimeter wave (mmW).

TABLE 4

| Frequency range | Corresponding | |
|---|---|---|
| designation | frequency range | Subcarrier spacing |
| FR1 | 450 MHz-6000 MHz | 15, 30, 60 kHz |
| FR2 | 24250 MHz-52600 MHz | 60, 120, 240 kHz |

As described above, the numerical value of the frequency range of the NR system can be changed. For example, FR1 can include a band of 410 MHz to 7125 MHz as shown in Table 5 below. That is, FR1 can include a frequency band of 6 GHz (or 5850, 5900, 5925 MHz, etc.) or higher. For example, the frequency band of 6 GHz (or 5850, 5900, 5925 MHz, etc.) or higher included in FR1 can include an unlicensed band. The unlicensed band can be used for various purposes, for example, it can be used for communication for vehicles (e.g., autonomous driving).

TABLE 5

| Frequency range | Corresponding | |
|---|---|---|
| designation | frequency range | Subcarrier spacing |
| FR1 | 410 MHz-7125 MHz | 15, 30, 60 kHz |
| FR2 | 24250 MHz-52600 MHz | 60, 120, 240 kHz |

In the NR system, OFDM (A) numerology (e.g., SCS, CP length, etc.) can be set differently between multiple cells that are merged into one terminal. Accordingly, the (absolute time) section of time resources (e.g., SF, slot or TTI) (conveniently, collectively called TU (Time Unit)) consisting of the same number of symbols can be set differently between the merged cells.

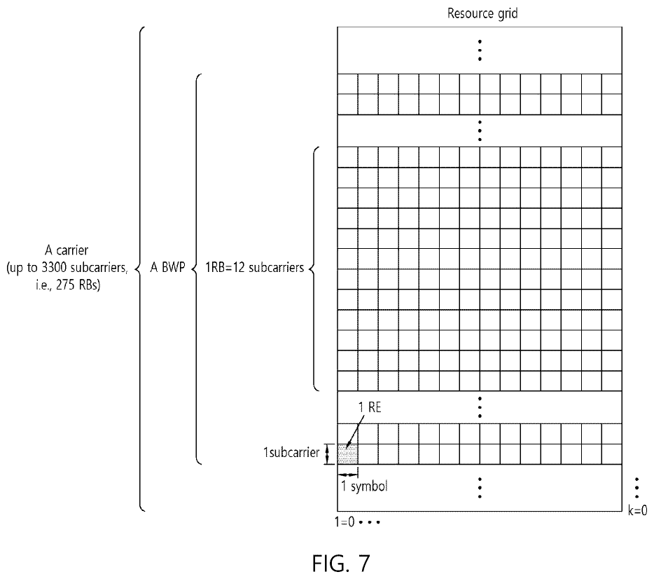

FIG. 7 shows the resource structure of the frequency and time domains of 5G NR.

Referring to FIG. 7, a slot includes multiple symbols in the time domain. For example, in the case of a normal CP, one slot may include 14 symbols, but in the case of an extended CP, one slot may include 12 symbols. Or, in the case of a normal CP, one slot may include 7 symbols, but in the case of an extended CP, one slot may include 6 symbols.

A carrier includes multiple subcarriers in the frequency domain. A RB (Resource Block) can be defined as multiple (e.g., 12) consecutive subcarriers in the frequency domain. A BWP (Bandwidth Part) can be defined as multiple (P) RBs in the frequency domain and can correspond to one numerology (e.g., SCS, CP length, etc.). A carrier can include at most N (e.g., 5) BWPs. Data communication can be performed through activated BWPs. Each element can be referred to as a Resource Element (RE) in the resource grid, and one complex symbol can be mapped.

A PDCCH (physical downlink control channel) can be composed of one or more CCEs (control channel elements) as shown in the following table.

TABLE 6

| Aggregation Level | Number of CCEs |
|---|---|
| 1 | 1 |
| 2 | 2 |
| 4 | 4 |
| 8 | 8 |
| 16 | 16 |

That is, PDCCH can be transmitted through a resource consisting of 1, 2, 4, 8, or 16 CCEs. Here, CCE is composed of 6 REGs (resource element groups), and one REG consists of one resource block in the frequency domain and one OFDM (orthogonal frequency division multiplexing) symbol in the time domain.

Meanwhile, in NR, a new unit called a control resource set (CORESET) can be introduced. The terminal can receive PDCCH in the CORESET.

Hereinafter, a carrier aggregation (CA) system is described.

A carrier aggregation system refers to aggregating multiple component carriers (CCs). Due to this carrier aggregation, the meaning of the existing cell has changed. According to carrier aggregation, a cell can mean a combination of a downlink component carrier and an uplink component carrier, or a single downlink component carrier.

In addition, in carrier aggregation, cells can be divided into a primary cell, a secondary cell, and a serving cell. A primary cell refers to a cell operating on a primary frequency, and refers to a cell on which a UE performs an initial connection establishment procedure or a connection re-establishment procedure with a base station, or a cell designated as a primary cell during a handover procedure. A secondary cell refers to a cell operating on a secondary frequency, and is set once an RRC connection is established and used to provide additional radio resources.

As described above, carrier aggregation systems can support multiple component carriers (CCs), i.e., multiple serving cells, unlike single-carrier systems.

Such carrier aggregation systems can support cross-carrier scheduling. Cross-carrier scheduling is a scheduling method that can allocate resources of PDSCH transmitted through other component carriers via PDCCH transmitted through a specific component carrier and/or allocate resources of PUSCH transmitted through other component carriers other than the component carriers that are basically linked with the specific component carrier.

Hereinafter, the next-generation communication system after 5G or 5G-Advanced is described. The next-generation communication system is referred to as a 6G system for convenience.

The 6G (wireless communication) system aims to provide (i) very high data rates per device, (ii) a very large number of connected devices, (iii) global connectivity, (iv) very low latency, (v) reduced energy consumption of battery-free IoT devices, (vi) ultra-reliable connectivity, and (vii) connected intelligence with machine learning capabilities. The usage scenarios of the 6G system can be divided into six aspects: Immersive Communication, Hyper Reliable & Low-Latency Communication, Massive Communication, Ubiquitous Connectivity, Integrated AI and Communication, and Integrated Sensing and Communication. Although the requirements or key performance indicators (KPIs) for the 6G system have not been determined yet, it is expected to have the requirements as shown in Table 7 below. That is, Table 7 is a table showing an example of the requirements of a 6G system.

TABLE 7

| | |
|---|---|
| peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

6G systems can have key factors such as Enhanced mobile broadband (eMBB), Ultra-reliable low latency communications (URLLC), massive machine-type communication (mMTC), AI integrated communication, Tactile internet, High throughput, High network capacity, High energy efficiency, Low backhaul and access network congestion, and Enhanced data security.

Hereinafter, Artificial Intelligence (AI) is explained.

The most important and newly introduced technology in the 6G system is AI. The 4G system did not involve AI. The 5G system will support partial or very limited AI. However, the 6G system will be fully AI-supported for automation. Advances in machine learning will create more intelligent networks for real-time communications in 6G. Introducing AI in communications can simplify and improve real-time data transmission. AI can use a lot of analytics to determine how complex target tasks are performed. In other words, AI can increase efficiency and reduce processing delays.

Time-consuming tasks such as handover, network selection, and resource scheduling can be performed instantly using AI. AI can also play a significant role in M2M, machine-to-human, and human-to-machine communication. AI can also be a rapid communication in BCI (Brain Computer Interface). AI-based communication systems can be supported by metamaterials, intelligent structures, intelligent networks, intelligent devices, intelligent cognitive radios, self-sustaining wireless networks, and machine learning.

Recently, there have been attempts to integrate AI with wireless communication systems, but these have been focused on the application layer, network layer, and especially deep learning in the field of wireless resource management and allocation. However, these studies are gradually developing into the MAC layer and the physical layer, and in particular, there are attempts to combine deep learning with wireless transmission in the Physical layer. AI-based physical layer transmission means applying signal processing and communication mechanisms based on AI drivers, rather than traditional communication frameworks, in terms of fundamental signal processing and communication mechanisms. For example, deep learning-based channel coding and decoding, deep learning-based signal estimation and detection, deep learning-based MIMO mechanism, and AI-based resource scheduling and allocation can be included.

Machine learning can be used for channel estimation and channel tracking, and can be used for power allocation, interference cancellation, etc. in the physical layer of the downlink (DL). In addition, machine learning can be used for antenna selection, power control, and symbol detection in MIMO systems.

However, the application of DNN for transmission in the physical layer may have the following problems.

Deep learning-based AI algorithms require a large amount of training data to optimize training parameters. However, due to limitations in obtaining data in a specific channel environment as training data, a large amount of training data is used offline. Static training on training data in a specific channel environment may cause a contradiction between the dynamic characteristics and diversity of the wireless channel.

Also, current deep learning mainly targets real signals. However, the signals of the physical layer of wireless communication are complex signals. In order to match the characteristics of wireless communication signals, more research is needed on neural networks that detect complex domain signals.

Hereinafter, machine learning will be discussed in more detail.

Machine learning refers to a series of operations that train machines to create machines that can perform tasks that people can or cannot do. Machine learning requires data and a learning model. In machine learning, data learning methods can be broadly divided into three types: supervised learning, unsupervised learning, and reinforcement learning.

Neural network learning is to minimize the error of the output. Neural network learning is a process of repeatedly inputting learning data into the neural network, calculating the neural network output and target error for the learning data, and backpropagating the neural network error from the output layer of the neural network to the input layer in the direction of reducing the error, thereby updating the weights of each node of the neural network.

Supervised learning uses training data with correct answers labeled for training data, and unsupervised learning may use training data with unlabeled answers. That is, for example, in the case of supervised learning for data classification, the training data can be data with categories labeled for each training data. The labeled training data is input to a neural network, and the error can be calculated by comparing the output (category) of the neural network with the label of the training data. The calculated error is backpropagated in the neural network in the reverse direction (i.e., from the output layer to the input layer), and the connection weights of each node in each layer of the neural network can be updated according to the backpropagation. The amount of change in the connection weights of each node that is updated can be determined according to the learning rate. The neural network's calculation of the input data and the backpropagation of the error can constitute a learning cycle (epoch). The learning rate can be applied differently depending on the number of repetitions of the learning cycle of the neural network. For example, in the early stages of learning a neural network, a high learning rate can be used to allow the network to quickly reach a certain level of performance, thereby increasing efficiency, while in the later stages of learning, a low learning rate can be used to increase accuracy.

Depending on the characteristics of the data, the learning method may vary. For example, if the goal is to accurately predict data transmitted from the transmitter to the receiver in a communication system, it is preferable to perform learning using supervised learning rather than unsupervised learning or reinforcement learning.

The learning model corresponds to the human brain, and the most basic linear model can be thought of, but the machine learning paradigm that uses highly complex neural network structures, such as artificial neural networks, as learning models is called deep learning.

The neural network cores used in learning methods are largely divided into deep neural networks (DNNs), convolutional deep neural networks (CNNs), and recurrent neural networks (RNNs, Recurrent Boltzmann Machines).

An artificial neural network is an example of connecting multiple perceptrons.

Hereinafter, THz (Tera-Hertz) communication is explained.

The data transmission rate can be increased by increasing the channel bandwidth. Since a high-frequency band must be used to easily obtain a wide channel bandwidth, a communication method using a sub-THz band, which is a frequency band higher than 100 GHz, and a THz band higher than that is also being considered. A communication method using a high frequency band can apply advanced massive MIMO technology because the antenna size and the gap between antennas are smaller. THz waves, also known as submillimeter waves, generally refer to a frequency band between 0.1 THz and 10 THz with a corresponding wavelength ranging from 0.03 mm to 3 mm. The 100 GHz-300 GHz band range (Sub-THz band) is considered to be the main part of the THz band for cellular communications. For 5G mobile communications, a frequency band of up to 100 GHz has been considered, and the Sub-THz band and THz band are expected to be used in 6G mobile communications.

6G mobile communications will use Sub-THz and THz bands in addition to the existing mmWave band. Adding the Sub-THz band to the mmWave band makes it easier to increase the channel bandwidth because it uses much more frequency resources, which in turn increases the data transmission rate and cell throughput. Among the defined THz bands, 300 GHz-3 THz is in the far infrared (IR) frequency band. The 300 GHz-3 THz band is part of the optical band, but is at the boundary of the optical band and is just behind the RF band. Therefore, the 300 GHz-3 THz band shows similarities with RF.

The key characteristics of THz communications include (i) a fairly wide channel bandwidth that can be widely used to support very high data rates, and (ii) high path loss at high frequencies (highly directional antennas are essential). Because the wavelength is small, the antenna size is small and the spacing between the antennas is also very small, so a fairly large number of antennas can be placed in a small area. The narrow beam generated by applying beamforming to these many antennas can reduce interference. In other words, the small wavelength of THz signals allows a much larger number of antenna elements to be integrated into devices and BSs operating in this band. This can enable the use of advanced adaptive array techniques to overcome range limitations.

THz wireless communication uses THz waves with a frequency of approximately 0.1 to 10 THz (1 THz=1000 GHz) for wireless communication, and can refer to terahertz (THz) band wireless communication that uses a very high carrier frequency of 100 GHz or higher. THz waves are located between the RF (Radio Frequency)/millimeter (mm) and infrared bands, and (i) compared to visible light/infrared light, they penetrate non-metallic/non-polarizable materials well, and compared to RF/millimeter waves, they have a shorter wavelength, so they have high linearity and can enable beam focusing. In addition, since the photon energy of THz waves is only a few meV, they have the characteristic of being harmless to the human body. The frequency bands expected to be used for THz wireless communication may be the D-band (110 GHz to 170 GHz) or H-band (220 GHz to 325 GHz) bands where propagation loss due to absorption of molecules in the air is small. Discussions on standardization of THz wireless communication are being centered around the IEEE 802.15 THz working group in addition to 3GPP, and standard documents issued by the IEEE 802.15 Task Group (TG3d, TG3e) may specify or supplement the contents described in this specification. THz wireless communication can be applied to wireless cognition, sensing, imaging, wireless communication, THz navigation, etc.

THz wireless communication scenarios can be categorized into macro networks, micro networks, and nanoscale networks. In macro networks, THz wireless communication can be applied to V2V (Vehicle-to-Vehicle) communication and backhaul/fronthaul connections. In micro networks, THz wireless communication can be applied to fixed point-to-point or multi-point connections such as indoor small cells, wireless connections in data centers, and near-field communications such as kiosk downloading.

Hereinafter, the proposed methods of the present disclosure are described.

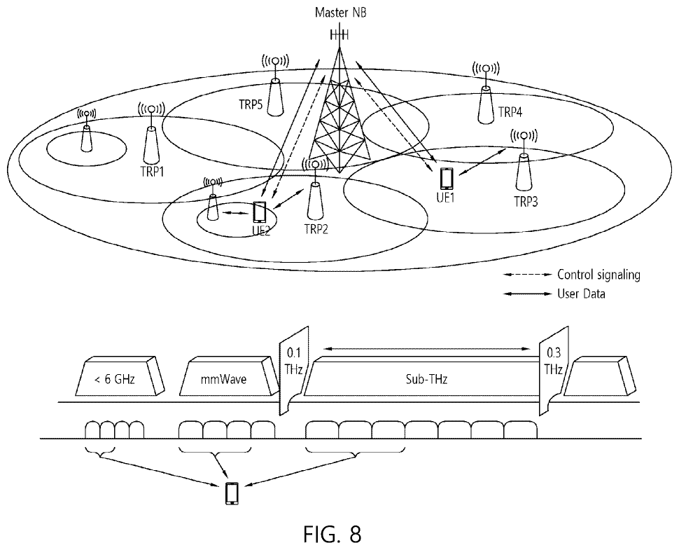

FIG. 8 illustrates an example in which carriers in the below-6 GHz band, mm Wave band, and sub-THz band are aggregated.

When using ultra-widebands such as mmWave or sub-THz bands, CA can be much easier to implement in base stations and terminals than using a single channel bandwidth as the frequency band. In particular, when the frequency bandwidth to be used is very wide and the performance of RF components is insufficient to support the wide frequency band, or when terminals and systems using various RF bands coexist, CA can be effective.

In this case, in order to support a large number of CCs (Component Carriers) at the same time from a single terminal, the terminal specifications may have to be very high. Even if the terminal specifications are high and can support a large number of CCs, the actual case of transmitting and receiving using a large number of CCs may be a special case that requires a high data transmission rate. Therefore, in the general case of using only some CCs among a large number of CCs, it may be necessary to communicate using the optimal CC.

In addition, since the channel environment varies significantly depending on the location of the terminal within the cell, the best frequency band for the terminal in a wide ultra-wide band can vary significantly depending on time and space. In particular, when configuring cell coverage using multiple Transmission and Reception Points (TRPs) in an ultra-high frequency band, the channel condition can vary significantly depending on location and time.

Therefore, even if the system supports CA using multiple CCs of various frequency bands including ultra-wideband, the optimal CC and/or the best combination of CCs among multiple CCs (or CC set) may vary for each terminal depending on time, space, and service in use. In addition, the optimal CC combination may vary depending on the capabilities of the terminal, such as the output power of one terminal and the number of CCs that can be supported simultaneously.

When using multiple bands such as mmWave and Sub-THz and multiple TRPs in a single cell, the optimal CC combination continuously changes in time and space depending on the current channel conditions and serving TRP(s) of the terminal. Therefore, the optimal CC combination needs to be continuously updated and reflected for efficient transmission.

Accordingly, when multiple bands such as mmWave and Sub-THz and multiple TRPs are used in a single cell, a method, which continuously updates and applies an optimal CC combination that reflects the situation that continuously changes in time and space for each terminal according to the current channel situation and serving TRP of the terminal, may be considered. According to the above method, the throughput and energy efficiency of each terminal and the system can be improved. In addition, when the system applies CA to the terminal, the system determines the optimal CC set by reflecting the channel information for multiple CCs or the information about the optimal CCs received from the terminal, the interference within the cell, the usage status of frequency resources, etc., and allocates frequency resources based on this, thereby providing an optimal link with each terminal and significantly reducing interference signals within the cell.

For example, a system (a base station or a network) can transmit information about the configuration of an ultra-wideband CA using the mmWave or Sub-THz band to terminals in the cell in advance through system information or RRC configuration information. In addition, the information about the configuration of the ultra-wideband CA can be transmitted to the terminals through a MAC message (e.g., MAC PDU or MAC CE) or DCI (Downlink Control Information). Here, the information about the configuration of the ultra-wideband CA can be transmitted in the form of common signaling for the entire cell or a specific group of terminals, or can be transmitted in the form of dedicated signaling for a specific terminal. The terminal can receive the configuration information of the ultra-wideband CA in advance through system information or RRC configuration information, MAC message or DCI, and then transmit information about the best CC combination in the current situation for the CC corresponding to the CA configuration to the system according to the capability of the terminal.

For this purpose, channel state measurement for CCs can be performed. Herein, the method can be performed in the form of periodic, semi-static, and aperiodic, and can vary depending on the setting of the system. Here, the periodic method can be a method in which the channel state measurement is continuously performed at specific intervals. In addition, the semi-static method can be a method in which periodic channel measurement is activated/deactivated depending on a specific channel state (for example, a situation in which the channel state becomes worse than a preset value, etc.) or a setting in the system. In addition, the aperiodic method can be a method in which the terminal measures only in a situation/case indicated by the system.

The system can update the primary CC (PCC) of the terminal periodically or according to specific conditions by utilizing the information about the CC transmitted by the terminal, and can also continuously update the secondary CC(s) (SCC(s)). Herein, the primary CC can be updated even when it is in the IDLE state. That is, unlike the existing 3GPP standards (LTE series or 5G), when CA is applied, the primary CC and secondary CC(s) can be updated according to the channel status of the terminal among a large number of CCs.

In addition, control information for the PCC and SCCs applied when performing CA using the optimal CC set by reflecting feedback from the terminal can be updated through RRC signaling, MAC CE (Medium Access Control-Control Element), etc.

In addition, among the optimal CC sets, the CCs used for actual transmission may be all CCs of the optimal CC set or some of the optimal CC set. Accordingly, information on the CCs used for actual transmission may be transmitted to the terminal through control information (e.g., RRC signaling, MAC CE, DCI (Downlink Control Information), etc.).

Various methods can be considered for reporting the results of a terminal measuring a large number of CCs for an ultra-wideband CA to the system. For example, detailed values for the channel quality of each CC can be fed back. Also, only the channel quality ranking for all CCs can be fed back. Also, the terminal can select as many CCs as the terminal can support according to the capability of the terminal, and feed back the index and detailed values of the channel quality for the corresponding CCs to the system. Also, the terminal can select as many CCs as the terminal can support according to the capability of the terminal, and feed back only the index and ranking (e.g., channel quality ranking) of the corresponding CCs to the system. In this case, the system can receive a report on the measurement results of the terminal and perform an update of the optimal CC set for the terminal based on the measurement results.

Meanwhile, CA can be applied to all of the Sub-6 GHZ, mm Wave bands, and Sub-THz bands. Therefore, the combination of CCs applied to CA can vary depending on whether the terminal supports multi-band.

When CA is applied and a communication device transmits using multiple CCs, information about the CC used may be included in the resource allocation information transmitted via DCI. In addition, when multi-band CA is used, resource allocation information of other bands or other CCs may also be transmitted via CCs that use other frequencies (either the same band or a different band) that are responsible for transmitting control signal information. This can be viewed as a kind of extended concept of Cross-Carrier Scheduling. Here, since each corresponding CC also has a channel such as PDCCH (Physical Downlink Control Channel) that can transmit DCI, resource allocation information may also be transmitted via each CC.

If the location or antenna pattern of the TRP is fixed, the channel status for each CC at one location within the cell can be almost similar over time. Therefore, the accumulated optimal CC information collected from the terminal or the channel status information of the CC is analyzed by the AI system, and the system can preset and utilize the optimal CC set according to the capability and location of the terminal.

If analog beamforming is applied to TRP and beam sweeping is applied, the optimal CC set may vary not only depending on the location of the terminal but also depending on the time. Therefore, information for determining the optimal CC set can be collected by the terminal and transmitted to the system. In addition, even if beam sweeping is applied to TRPs, the channel status of CCs used for CA is likely to be repeated with a certain cycle at a specific location. Therefore, the system can collect a lot of information collected from each terminal, analyze it with an AI system, and set the optimal CC set in advance according to the capability and location of the terminal and utilize it.

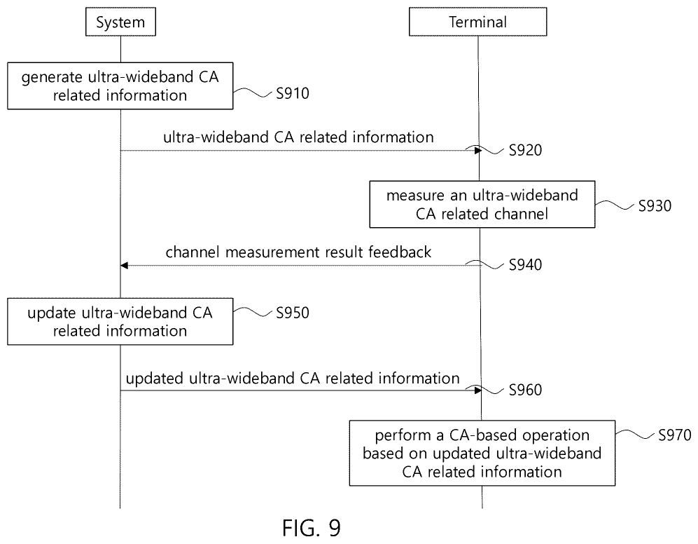

FIG. 9 is a flowchart of an example of an optimal CC set setting method for ultra-wideband CA according to some implementations of the present specification. Here, the system of FIG. 9 may be a base station.

Referring to FIG. 9, the system may generate ultra-wideband CA related information (S910). The system may transmit the ultra-wideband CA related information to a terminal (S920). Here, the ultra-wideband CA related information may be transmitted as included in system information or RRC setting information.

The terminal can measure an ultra-wideband CA related channel (S930). The terminal can feed back the channel measurement result to the system (S940).

The system can update the ultra-wideband CA related information (S950). The system can transmit the updated ultra-wideband CA related information to the terminal (S960). Herein, the updated ultra-wideband CA related information can be transmitted through RRC configuration information, MAC CE, or DCI. The terminal can perform a CA-based operation based on the updated ultra-wideband CA related information (S970).

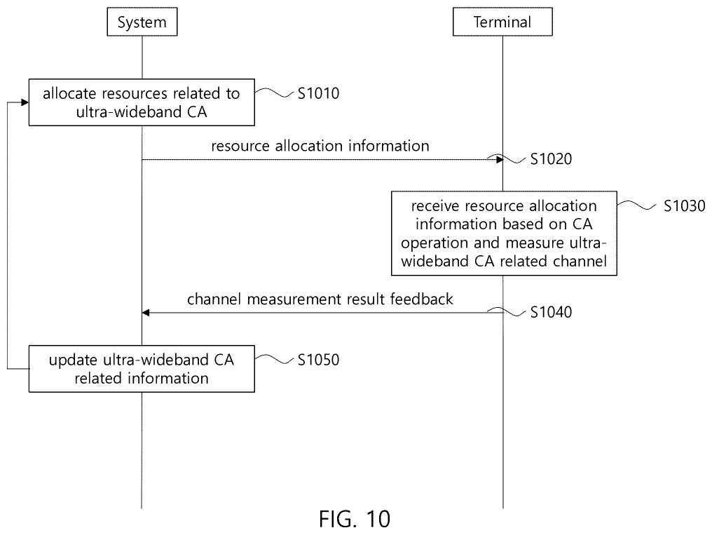

FIG. 10 is a flowchart of an example of a method for performing a CA-based operation reflecting an optimal CC set by a terminal in an ACTIVE state according to some implementations of the present specification. Here, the system of FIG. 10 may be a base station.

Referring to FIG. 10, the system can allocate resources related to ultra-wideband CA (S1010). The system can transmit resource allocation information to the terminal (S1020). Herein, the resource allocation information can indicate to the terminal the resources allocated for the ultra-wideband CA performed in step S1010.

The terminal may receive the resource allocation information based on the CA operation and measure the ultra-wideband CA related channel (S1030). The terminal may feed back the channel measurement result to the system (S1040). The system may update the ultra-wideband CA related information (S1050). Thereafter, the system may perform step S1010 again.

Hereinafter, an example of a communication system to which the present invention is applied is described.

Although not limited thereto, the various descriptions, functions, procedures, suggestions, methods and/or operational flowcharts of the present invention disclosed in this disclosure may be applied to various fields requiring wireless communication/connectivity (e.g., 5G) between devices.

Hereinafter, more specific examples will be provided with reference to the drawings. In the drawings/descriptions below, the same drawing symbols may illustrate identical or corresponding hardware blocks, software blocks, or functional blocks, unless otherwise described.

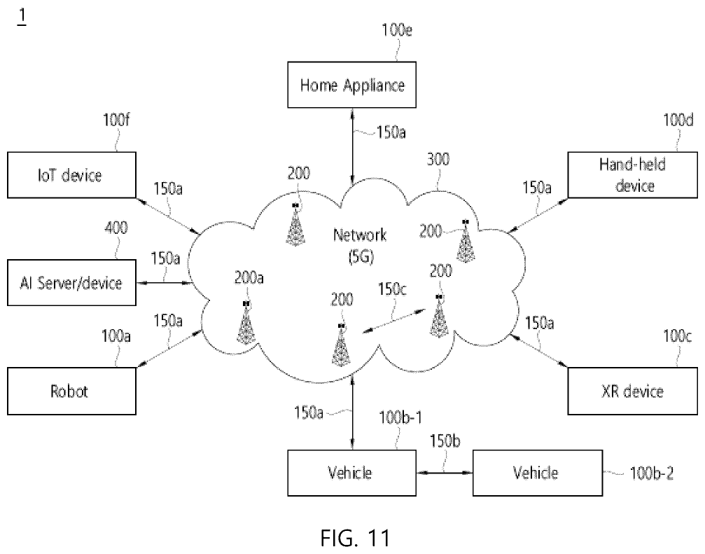

FIG. 11 illustrates an example of a communication system (1) applied to the present invention.

Referring to FIG. 11, a communication system (1) applied to the present invention includes a wireless device, a base station, and a network. Here, the wireless device means a device that performs communication using a wireless access technology (e.g., 5G NR (New RAT), LTE (Long Term Evolution)) and may be referred to as a communication/wireless/5G device. Although not limited thereto, the wireless device may include a robot (100a), a vehicle (100b-1, 100b-2), an XR (extended Reality) device (100c), a hand-held device (100d), a home appliance (100e), an IoT (Internet of Thing) device (100f), and an AI device/server (400). For example, the vehicle may include a vehicle equipped with a wireless communication function, an autonomous vehicle, a vehicle capable of performing vehicle-to-vehicle communication, etc. Here, the vehicle may include a UAV (Unmanned Aerial Vehicle) (e.g., a drone). XR devices include AR (Augmented Reality)/VR (Virtual Reality)/MR (Mixed Reality) devices and can be implemented in the form of HMD (Head-Mounted Device), HUD (Head-Up Display) installed in a vehicle, television, smartphone, computer, wearable device, home appliance, digital signage, vehicle, robot, etc. Portable devices can include smartphone, smart pad, wearable device (e.g., smart watch, smart glass), computer (e.g., laptop, etc.). Home appliances can include TV, refrigerator, washing machine, etc. IoT devices can include sensors, smart meters, etc. For example, base stations and networks can also be implemented as wireless devices, and a specific wireless device (200a) can act as a base station/network node to other wireless devices.

Here, the wireless communication technology implemented in the wireless device of the present specification may include LTE, NR, and 6G, as well as Narrowband Internet of Things for low-power communication. Herein, for example, NB-IoT technology may be an example of LPWAN (Low Power Wide Area Network) technology, and may be implemented with standards such as LTE Cat NB1 and/or LTE Cat NB2, and is not limited to the above-described names. Additionally or alternatively, the wireless communication technology implemented in the wireless device of the present specification may perform communication based on LTE-M technology. At this time, for example, LTE-M technology may be an example of LPWAN technology, and may be called by various names such as eMTC (enhanced Machine Type Communication). For example, the LTE-M technology can be implemented by at least one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless device of the present specification can include at least one of ZigBee, Bluetooth, and Low Power Wide Area Network (LPWAN) considering low-power communication, and is not limited to the above-described names. For example, the ZigBee technology can create PAN (personal area networks) related to small/low-power digital communication based on various standards such as IEEE 802.15.4, and can be called by various names.

Wireless devices (100a to 100f) can be connected to a network (300) via a base station (200). Artificial Intelligence (AI) technology can be applied to the wireless devices (100a to 100f), and the wireless devices (100a to 100f) can be connected to an AI server (400) via the network (300). The network (300) can be configured using a 3G network, a 4G (e.g., LTE) network, a 5G (e.g., NR) network, etc. The wireless devices (100a to 100f) can communicate with each other via the base station (200)/network (300), but can also communicate directly (e.g., sidelink communication) without going through the base station/network. For example, vehicles (100b-1, 100b-2) can communicate directly (e.g. V2V (Vehicle to Vehicle)/V2X (Vehicle to everything) communication). Also, IoT devices (e.g., sensors) can communicate directly with other IoT devices (e.g., sensors) or other wireless devices (100a to 100f).

Wireless communication/connection (150a, 150b, 150c) can be established between wireless devices (100a to 100f)/base stations (200), and base stations (200)/base stations (200). Here, the wireless communication/connection can be achieved through various wireless access technologies (e.g., 5G NR) such as uplink/downlink communication (150a), sidelink communication (150b) (or, D2D communication), and communication between base stations (150c) (e.g., relay, IAB (Integrated Access Backhaul). Through the wireless communication/connection (150a, 150b, 150c), a wireless device and a base station/wireless device, and a base station and a base station can transmit/receive wireless signals to/from each other. For example, the wireless communication/connection (150a, 150b, 150c) can transmit/receive signals through various physical channels. To this end, at least some of various configuration information setting processes for transmitting/receiving wireless signals, various signal processing processes (e.g., channel encoding/decoding, modulation/demodulation, resource mapping/demapping, etc.), and resource allocation processes can be performed based on various proposals of the present invention.

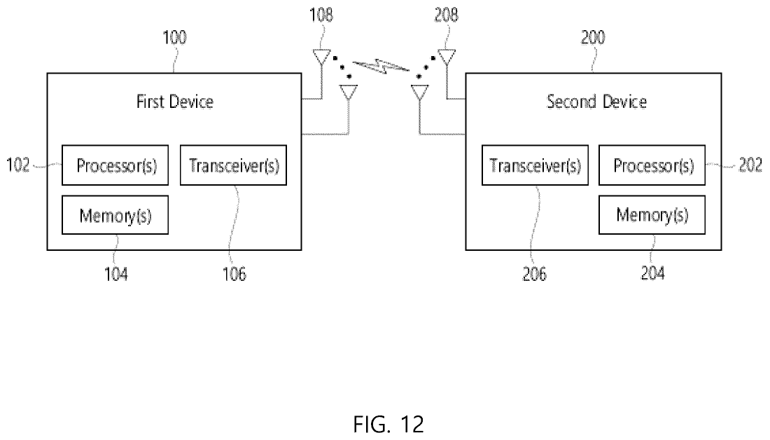

FIG. 12 illustrates an example of a wireless device applicable to the present invention.

Referring to FIG. 12, the first wireless device (100) and the second wireless device (200) can transmit and receive wireless signals through various wireless access technologies (e.g., LTE, NR). Here, {the first wireless device (100), the second wireless device (200)} can correspond to {the wireless device (100x), the base station (200)} and/or {the wireless device (100x), the wireless device (100x)} of FIG. 11.

A first wireless device (100) includes one or more processors (102) and one or more memories (104), and may additionally include one or more transceivers (106) and/or one or more antennas (108). The processor (102) controls the memory (104) and/or the transceiver (106), and may be configured to implement the descriptions, functions, procedures, suggestions, methods, and/or operational flowcharts disclosed herein. For example, the processor (102) may process information in the memory (104) to generate first information/signal, and then transmit a wireless signal including the first information/signal via the transceiver (106). Additionally, the processor (102) may receive a wireless signal including second information/signal via the transceiver (106), and then store information obtained from signal processing of the second information/signal in the memory (104). The memory (104) may be connected to the processor (102) and may store various information related to the operation of the processor (102). For example, the memory (104) may perform some or all of the processes controlled by the processor (102), or may store software codes including commands for performing the descriptions, functions, procedures, proposals, methods, and/or operation flowcharts disclosed herein. Here, the processor (102) and the memory (104) may be part of a communication modem/circuit/chip designed to implement wireless communication technology (e.g., LTE, NR). The transceiver (106) may be connected to the processor (102) and may transmit and/or receive wireless signals via one or more antennas (108). The transceiver (106) may include a transmitter and/or a receiver. The transceiver (106) may be used interchangeably with a RF (Radio Frequency) unit. In the present invention, a wireless device may also mean a communication modem/circuit/chip.

The second wireless device (200) includes one or more processors (202), one or more memories (204), and may additionally include one or more transceivers (206) and/or one or more antennas (208). The processor (202) may be configured to control the memories (204) and/or the transceivers (206), and implement the descriptions, functions, procedures, suggestions, methods, and/or operational flowcharts disclosed herein. For example, the processor (202) may process information in the memory (204) to generate third information/signals, and then transmit a wireless signal including the third information/signals via the transceivers (206). Additionally, the processor (202) may receive a wireless signal including fourth information/signals via the transceivers (206), and then store information obtained from signal processing of the fourth information/signals in the memory (204). The memory (204) may be connected to the processor (202) and may store various information related to the operation of the processor (202). For example, the memory (204) may perform some or all of the processes controlled by the processor (202), or may store software codes including commands for performing the descriptions, functions, procedures, proposals, methods, and/or operational flowcharts described in the present document. Here, the processor (202) and the memory (204) may be part of a communication modem/circuit/chip designed to implement wireless communication technology (e.g., LTE, NR). The transceiver (206) may be connected to the processor (202) and may transmit and/or receive wireless signals via one or more antennas (208). The transceiver (206) may include a transmitter and/or a receiver. The transceiver (206) may be used interchangeably with a RF unit. In the present invention, a wireless device may also mean a communication modem/circuit/chip.

Hereinafter, hardware elements of the wireless device (100, 200) will be described in more detail. Although not limited thereto, one or more protocol layers may be implemented by one or more processors (102, 202). For example, one or more processors (102, 202) may implement one or more layers (e.g., functional layers such as PHY, MAC, RLC, PDCP, RRC, SDAP). One or more processors (102, 202) may generate one or more Protocol Data Units (PDUs) and/or one or more Service Data Units (SDUs) according to the descriptions, functions, procedures, proposals, methods and/or operational flowcharts disclosed herein. One or more processors (102, 202) may generate messages, control information, data or information according to the descriptions, functions, procedures, proposals, methods and/or operational flowcharts disclosed herein. One or more processors (102, 202) can generate signals (e.g., baseband signals) including PDUs, SDUs, messages, control information, data or information according to the functions, procedures, suggestions and/or methodologies disclosed herein, and provide the signals to one or more transceivers (106, 206). One or more processors (102, 202) can receive signals (e.g., baseband signals) from one or more transceivers (106, 206) and obtain PDUs, SDUs, messages, control information, data or information according to the descriptions, functions, procedures, suggestions, methods and/or operational flowcharts disclosed herein.

The one or more processors (102, 202) may be referred to as a controller, a microcontroller, a microprocessor, or a microcomputer. The one or more processors (102, 202) may be implemented by hardware, firmware, software, or a combination thereof. For example, one or more ASICs (Application Specific Integrated Circuits), one or more DSPs (Digital Signal Processors), one or more DSPDs (Digital Signal Processing Devices), one or more PLDs (Programmable Logic Devices), or one or more FPGAs (Field Programmable Gate Arrays) may be included in the one or more processors (102, 202). The descriptions, functions, procedures, suggestions, methods, and/or operational flowcharts disclosed herein may be implemented using firmware or software, and the firmware or software may be implemented to include modules, procedures, functions, etc. The descriptions, functions, procedures, suggestions, methods and/or operation flow diagrams invented in this document may be implemented using firmware or software configured to perform the descriptions, functions, procedures, suggestions, methods and/or operation flow diagrams invented in this document may be included in one or more processors (102, 202) or stored in one or more memories (104, 204) and executed by one or more processors (102, 202). The descriptions, functions, procedures, suggestions, methods and/or operation flow diagrams invented in this document may be implemented using firmware or software in the form of codes, instructions and/or a set of instructions.

One or more memories (104, 204) may be coupled to one or more processors (102, 202) and may store various forms of data, signals, messages, information, programs, codes, instructions and/or commands. The one or more memories (104, 204) may be comprised of ROM, RAM, EPROM, flash memory, hard drives, registers, cache memory, computer readable storage media and/or combinations thereof. The one or more memories (104, 204) may be located internally and/or externally to the one or more processors (102, 202). Additionally, the one or more memories (104, 204) may be coupled to the one or more processors (102, 202) via various technologies, such as wired or wireless connections.

One or more transceivers (106, 206) can transmit user data, control information, wireless signals/channels, etc., referred to in the methods and/or flowcharts of this document to one or more other devices. One or more transceivers (106, 206) can receive user data, control information, wireless signals/channels, etc., referred to in the descriptions, functions, procedures, suggestions, methods and/or flowcharts of this document from one or more other devices. For example, one or more transceivers (106, 206) can be coupled to one or more processors (102, 202) and can transmit and receive wireless signals. For example, one or more processors (102, 202) can control one or more transceivers (106, 206) to transmit user data, control information, or wireless signals to one or more other devices. Additionally, one or more processors (102, 202) may control one or more transceivers (106, 206) to receive user data, control information, or wireless signals from one or more other devices. Additionally, one or more transceivers (106, 206) may be coupled to one or more antennas (108, 208), and one or more transceivers (106, 206) may be configured to transmit and receive user data, control information, wireless signals/channels, or the like, as described in the description, function, procedure, proposal, method, and/or operational flowchart, herein, via one or more antennas (108, 208). In this document, one or more antennas may be multiple physical antennas, or multiple logical antennas (e.g., antenna ports). One or more transceivers (106, 206) may convert received user data, control information, wireless signals/channels, etc. from RF band signals to baseband signals in order to process the received user data, control information, wireless signals/channels, etc. using one or more processors (102, 202). One or more transceivers (106, 206) may convert processed user data, control information, wireless signals/channels, etc. from baseband signals to RF band signals using one or more processors (102, 202). For this purpose, one or more transceivers (106, 206) may include an (analog) oscillator and/or filter.

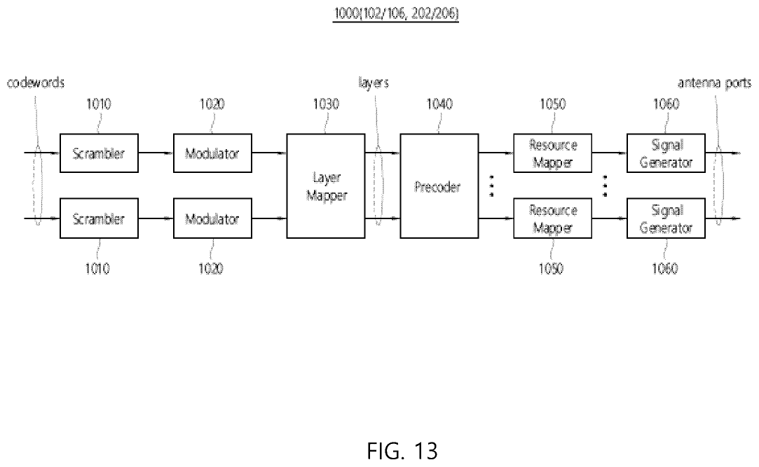

FIG. 13 illustrates an example of a process for generating a transmission signal from a transmitter.

Referring to FIG. 13, the signal processing circuit (1000) may include a scrambler (1010), a modulator (1020), a layer mapper (1030), a precoder (1040), a resource mapper (1050), and a signal generator (1060). Although not limited thereto, the operations/functions of FIG. 13 may be performed in the processor (102, 202) and/or the transceiver (106, 206) of FIG. 12. The hardware elements of FIG. 13 may be implemented in the processor (102, 202) and/or the transceiver (106, 206) of FIG. 12. For example, blocks 1010 to 1060 may be implemented in the processor (102, 202) of FIG. 12. Additionally, blocks 1010 to 1050 may be implemented in the processor (102, 202) of FIG. 12, and block 1060 may be implemented in the transceiver (106, 206) of FIG. 12.

The codeword can be converted into a wireless signal through the signal processing circuit (1000) of FIG. 13. Here, the codeword is an encoded bit sequence of an information block. The information block can include a transport block (e.g., UL-SCH transport block, DL-SCH transport block). The wireless signal can be transmitted through various physical channels (e.g., PUSCH, PDSCH).

Specifically, the codeword can be converted into a bit sequence scrambled by a scrambler (1010). The scramble sequence used for scrambling is generated based on an initialization value, and the initialization value may include ID information of the wireless device, etc. The scrambled bit sequence can be modulated into a modulation symbol sequence by a modulator (1020). The modulation scheme may include pi/2-BPSK (pi/2-Binary Phase Shift Keying), m-PSK (m-Phase Shift Keying), m-QAM (m-Quadrature Amplitude Modulation), etc. The complex modulation symbol sequence can be mapped to one or more transmission layers by a layer mapper (1030). The modulation symbols of each transmission layer can be mapped to the corresponding antenna port(s) by a precoder (1040) (precoding). The output z of the precoder (1040) can be obtained by multiplying the output y of the layer mapper (1030) by a precoding matrix W of N*M. Here, N is the number of antenna ports, and M is the number of transmission layers. Here, the precoder (1040) can perform precoding after performing transform precoding (e.g., DFT transform) on complex modulation symbols. Additionally, the precoder (1040) can perform precoding without performing transform precoding.

The resource mapper (1050) can map modulation symbols of each antenna port to time-frequency resources. The time-frequency resources can include a plurality of symbols (e.g., CP-OFDM symbols, DFT-s-OFDM symbols) in the time domain and a plurality of subcarriers in the frequency domain. The signal generator (1060) generates a wireless signal from the mapped modulation symbols, and the generated wireless signal can be transmitted to another device through each antenna. To this end, the signal generator (1060) can include an Inverse Fast Fourier Transform (IFFT) module, a Cyclic Prefix (CP) inserter, a Digital-to-Analog Converter (DAC), a frequency uplink converter, etc.

The signal processing process for receiving signals in a wireless device can be configured in reverse order of the signal processing process (1010 to 1060) of FIG. 13. For example, a wireless device (e.g., 100, 200 of FIG. 12) can receive a wireless signal from the outside through an antenna port/transceiver. The received wireless signal can be converted into a baseband signal through a signal restorer. To this end, the signal restorer can include a frequency downlink converter, an analog-to-digital converter (ADC), a CP remover, and a fast Fourier transform (FFT) module. Thereafter, the baseband signal can be restored to a codeword through a resource de-mapper process, a postcoding process, a demodulation process, and a de-scramble process. The codeword can be restored to an original information block through decoding. Accordingly, a signal processing circuit (not shown) for a received signal may include a signal restorer, a resource de-mapper, a postcoder, a demodulator, a de-scrambler and a decoder.

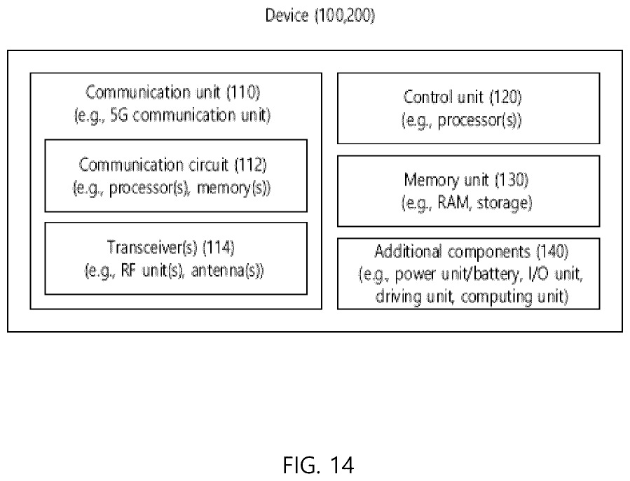

FIG. 14 shows another example of a wireless device applied to the present invention. The wireless device can be implemented in various forms depending on the use-example/service.

Referring to FIG. 14, the wireless device (100, 200) corresponds to the wireless device (100, 200) of FIG. 12 and may be composed of various elements, components, units, and/or modules. For example, the wireless device (100, 200) may include a communication unit (110), a control unit (120), a memory unit (130), and an additional element (140). The communication unit may include a communication circuit (112) and a transceiver(s) (114). For example, the communication circuit (112) may include one or more processors (102, 202) and/or one or more memories (104, 204) of FIG. 12. For example, the transceiver(s) (114) may include one or more transceivers (106, 206) and/or one or more antennas (108, 208) of FIG. 12. The control unit (120) is electrically connected to the communication unit (110), the memory unit (130), and the additional elements (140) and controls overall operations of the wireless device. For example, the control unit (120) may control electrical/mechanical operations of the wireless device based on programs/codes/commands/information stored in the memory unit (130). In addition, the control unit (120) may transmit information stored in the memory unit (130) to an external device (e.g., another communication device) via a wireless/wired interface through the communication unit (110), or store information received from an external device (e.g., another communication device) via a wireless/wired interface in the memory unit (130).

The additional element (140) may be configured in various ways depending on the type of the wireless device. For example, the additional element (140) may include at least one of a power unit/battery, an input/output unit (I/O unit), a driving unit, and a computing unit. Although not limited thereto, the wireless device may be implemented in the form of a robot (FIG. 11, 100a), a vehicle (FIG. 11, 100b-1, 100b-2), an XR device (FIG. 11, 100c), a portable device (FIG. 11, 100d), a home appliance (FIG. 11, 100e), an IoT device (FIG. 11, 100f), a digital broadcasting terminal, a hologram device, a public safety device, an MTC device, a medical device, a fintech device (or a financial device), a security device, a climate/environmental device, an AI server/device (FIG. 11, 400), a base station (FIG. 11, 200), a network node, etc. Wireless devices may be mobile or stationary, depending on the use/service.

In FIG. 14, various elements, components, units/parts, and/or modules within the wireless device (100, 200) may be entirely interconnected via a wired interface, or at least some may be wirelessly connected via a communication unit (110). For example, within the wireless device (100, 200), the control unit (120) and the communication unit (110) may be wired, and the control unit (120) and the first unit (e.g., 130, 140) may be wirelessly connected via the communication unit (110). In addition, each element, component, unit/part, and/or module within the wireless device (100, 200) may further include one or more elements. For example, the control unit (120) may be composed of one or more processor sets. For example, the control unit (120) may be composed of a set of a communication control processor, an application processor, an electronic control unit (ECU), a graphic processing processor, a memory control processor, etc. As another example, the memory unit (130) may be composed of RAM (Random Access Memory), DRAM (Dynamic RAM), ROM (Read Only Memory), flash memory, volatile memory, non-volatile memory, and/or a combination thereof.

The claims set forth in this specification may be combined in various ways. For example, the technical features of the method claims of this specification may be combined and implemented as a device, and the technical features of the device claims of this specification may be combined and implemented as a method. In addition, the technical features of the method claims of this specification and the technical features of the device claims of this specification may be combined and implemented as a device, and the technical features of the method claims of this specification and the technical features of the device claims of this specification may be combined and implemented as a method.

1. A method performed by a user equipment (UE) in a wireless communication system, the method comprising:
receiving, from a base station, first configuration information related to ultra-wideband carrier aggregation (CA), wherein the ultra-wideband CA is a CA in which at least one component carrier (CC) is used;
performing a channel measurement related to the ultra-wideband CA based on the first configuration information;
transmitting, to the base station, report information related to the channel measurement; and
receiving, from a base station, second configuration information related to the ultra-wideband CA.

2. The method of claim 1, wherein the first configuration information indicates a first set of CCs that the UE is capable of using—for the ultra-wideband CA.

3. The method of claim 1, wherein
the second configuration information indicates a second set of CCs that the UE is capable of using for the ultra-wideband CA, and
the second set is determined based on the report information.

4. The method of claim 1, wherein the first configuration information and the second configuration information are determined based on at least one of an interference within a cell associated with the base station and a usage of frequency resources associated with the cell.

5. The method of claim 1, wherein the first configuration information is transmitted based on radio resource control (RRC) signaling.

6. The method of claim 1, wherein the second configuration information is transmitted based on at least one of RRC signaling, medium access control-control element (MAC CE) or downlink control information (DCI).

7. The method of claim 1, wherein the report information is periodically transmitted by the UE.

8. The method of claim 1, wherein the report information is semi-persistently transmitted by the UE.

9. The method of claim 1, wherein the UE configures the ultra-wideband CA using at least some of the CCs included in the second configuration information.

10. A user equipment (UE) comprising:
one or more memories storing instructions;
one or more transceivers; and
one or more processors connecting the one or more memories to the one or more transceivers,
wherein the one or more processors are configured to execute the instructions for:
receiving, from a base station, first configuration information related to ultra-wideband carrier aggregation (CA), wherein the ultra-wideband CA is a CA in which at least one component carrier (CC) is used;
performing a channel measurement related to the ultra-wideband CA based on the first configuration information;
transmitting, to the base station, report information related to the channel measurement; and
receiving, from a base station, second configuration information related to the ultra-wideband CA.

11. The UE of claim 10, wherein the first configuration information indicates a first set of CCs that the UE is capable of using for the ultra-wideband CA.

12. The UE of claim 10, wherein
the second configuration information indicates a second set of CCs that the UE is capable of using for the ultra-wideband CA, and
the second set is determined based on the report information.

13. The UE of claim 10, wherein the first configuration information and the second configuration information are determined based on at least one of an interference within a cell associated with the base station and a usage of frequency resources associated with the cell.

14. The UE of claim 10, wherein
the first configuration information is transmitted based on radio resource control (RRC) signaling, and
the second configuration information is transmitted based on at least one of RRC signaling, medium access control-control element (MAC CE) or downlink control information (DCI).

15. The UE of claim 10, wherein the report information is periodically transmitted by the UE.

16. The UE of claim 10, wherein the report information is semi-persistently transmitted by the UE.

17. The UE of claim 10, wherein the UE configures the ultra-wideband CA using at least some of the CCs included in the second configuration information.

18. A method performed by a base station in a wireless communication system, the method comprising:
transmitting, to a user equipment (UE), first configuration information related to ultra-wideband carrier aggregation (CA), wherein the ultra-wideband CA is a CA in which at least one component carrier (CC) is used;
receiving, from the UE, report information related to the channel measurement to the base station, wherein the report information includes channel measurement information related to the ultra-wideband CA based on the first configuration information; and
transmitting, to the UE, second configuration information related to the ultra-wideband CA,
wherein the base station determines the second configuration information based on modifying the first configuration information based on the channel measurement information.

19. The method of claim 18, wherein
the first configuration information is transmitted based on radio resource control (RRC) signaling, and
the second configuration information is transmitted based on at least one of RRC signaling, medium access control-control element (MAC CE) or downlink control information (DCI).

20. The method of claim 18, wherein
the second configuration information indicates a set of CCs that the UE is capable of using for the ultra-wideband CA, and
the set includes CCs having a high communication quality for the UE among CCs related to the base station.
